(19) United States
(12) Patent Application Publication
(10) Pub. No.: US 2014/0305115 A1
(43) Pub. Date: Oct. 16, 2014

(54) CUSHION VALVE DEVICE AND MULTI-CUSHION VALVE UNIT INCLUDING THE SAME

(71) Applicant: KAWASAKI JUKOGYO KABUSHIKI KAISHA, Kobe-shi, Hyogo (JP)

(72) Inventors: Mikito Matsuda, Akashi-shi (JP); Kazuto Fujiyama, Kobe-shi (JP); Kenjiro Hara, Kobe-shi (JP); Kenichi Tominaga, Kakogawa-shi (JP)

(21) Appl. No.: 14/358,890

(22) PCT Filed: Oct. 25, 2012
(86) PCT No.: PCT/JP2012/006859

§ 371 Date: May 16, 2014

(30) Foreign Application Priority Data
Nov. 16, 2011 (JP) 2011-250409

(51) Int. Cl. E02F 9/22; F16K 15/18

(52) U.S. Cl. CPC E02F 9/2285; F16K 15/186; E02F 9/2228
USPC 60/338; 137/523

(57) ABSTRACT

A cushion valve device includes a valve block that includes first, second and first discharge passages. The first passage is disposed between a first supply/discharge passage of an operating valve and a first pilot passage of a switching valve, and includes a first throttle. The second passage is between a second supply/discharge passage of the operating valve and a second pilot passage of the switching valve. The first discharge passage connects to the first passage and a tank. A first check valve is provided on the first discharge passage. The first check valve includes: a poppet valve element configured to be seated on a valve seat portion, thereby closing the first discharge passage; and a piston configured to move the poppet valve element when the pressure of pilot oil in the second supply/discharge passage has become higher than or equal to a predetermined pressure, thereby opening the first discharge passage.

### TECHNICAL FIELD

The present invention relates to a cushion valve device disposed between an operating valve and a switching valve, the operating valve supplying pilot oil with a pressure corresponding to an operation of an operating tool, the switching valve controlling the direction of a hydraulic oil flow to an actuator in accordance with the pressure of the pilot oil, the cushion valve device being configured to reduce an impact shock in the actuator at start-up and stopping of the actuator. The present invention also relates to a multi-cushion valve unit including the cushion valve device.

### BACKGROUND ART

Construction machines include a hydraulic circuit for driving an actuator by remote control. Such a hydraulic circuit includes a pilot operating valve and a switching valve. The pilot operating valve includes two supply/discharge passages, and is configured to, in accordance with an operation of an operating tool, supply pilot oil to one of the supply/discharge passages and connect the other supply/discharge passage to a tank. These two supply/discharge passages are connected to two pilot passages of the switching valve. The switching valve is configured to switch the direction of hydraulic oil flowing from a pump to an actuator in accordance with a pressure difference between the two pilot passages, thereby switching between start-up and stopping of the actuator.

In the hydraulic circuit with the above-described configuration, in a case where the switching speed of the switching valve is fast, at the start-up of the actuator, the hydraulic oil flows to the actuator at once, causing an impact shock. Further, at the time of stopping the actuator, the flow of the hydraulic oil to the actuator suddenly stops, which also causes an impact shock similar to the case of start-up. Usually, in order to reduce such an impact shock, a throttle is formed in a supply/discharge passage, and thereby the switching speed of the switching valve is suppressed. However, in a case where a throttle is formed in a supply/discharge passage, if the viscosity of the pilot oil is high, for example, in a low-temperature environment, then the actuator's response to an operation of the operating tool becomes less responsive due to an influence of the throttle. In order to solve such a problem, Patent Literature 1 discloses providing a cushion valve on a supply/discharge passage.

The cushion valve of Patent Literature 1 is a spool-type valve, which forms a variable throttle in the supply/discharge passage. Accordingly, when the operating tool is operated to a large degree, the spool is moved to increase the passage's cross-sectional area, thereby reducing the influence of the viscosity of the pilot oil on the responsiveness of the actuator.

### CITATION LIST

### Patent Literature

PTL 1: Japanese Laid-Open Utility Model Application Publication No. 6-56157

### SUMMARY OF INVENTION

### Technical Problem

Construction machines include various components such as an engine and a pump, and space in which the components are disposed is limited. Space for disposing a cushion valve is also limited, and it is preferred that the cushion valve can be disposed in a gap around the engine, pump, or the like, and that the cushion valve can be designed in a shape matching the gap.

Since the cushion valve disclosed in Patent Literature 1 is a spool-type valve, if the degree of opening of the cushion valve is small, then loss in hydraulic pressure occurring between before and after passing through the cushion valve is great. Therefore, it is preferred to increase the spool stroke of the cushion valve in order to reduce the hydraulic pressure loss. In this case, however, the longitudinal dimension of the spool is increased, and as a result, the degree of freedom in the shape of the cushion valve is reduced. That is, the cushion valve disclosed in Patent Literature 1 cannot be designed in a shape that matches the aforementioned gap. Moreover, since the cushion valve disclosed in Patent Literature 1 is a spool-type valve, there is a possibility that contaminants become caught and stuck between the spool and housing. Thus, contamination resistance of the cushion valve disclosed in Patent Literature 1 is low.

In view of the above, an object of the present invention is to provide a cushion valve device with high contamination resistance and high degree of freedom in its shape.

### Solution to Problem

The present invention is a cushion valve device disposed between an operating valve and a switching valve. The operating valve is configured to supply pilot oil with a pressure corresponding to an operating amount of an operating tool to one of a first supply/discharge passage and a second supply/discharge passage in accordance with an operating direction of the operating tool, and connect another one of the first supply/discharge passage and the second supply/discharge passage to a tank. The switching valve is configured to switch a direction of hydraulic oil flowing to an actuator in accordance with a pressure difference between a first pilot passage connected to the first supply/discharge passage and a second pilot passage connected to the second supply/discharge passage. The cushion valve device includes: a valve block including a first passage, a second passage, and a first discharge passage, the first passage including a first throttle and being disposed between the first supply/discharge passage and the first pilot passage, the second passage being disposed between the second supply/discharge passage and the second pilot passage, the first discharge passage branching off from the first passage between the first throttle and the first pilot passage and connecting the first passage and the tank; and a first pilot-to-open check valve configured to open the first discharge passage when the pressure of the pilot oil that flows through the second supply/discharge passage has become higher than or equal to a predetermined pressure, and close the first discharge passage when the pressure of the pilot oil that flows through the second supply/discharge passage has become lower than the predetermined pressure. When the pressure of the pilot oil that flows through the second supply/discharge passage is lower than the predetermined pressure, the first pilot passage is connected to the tank via the first passage and the first supply/discharge passage.

According to the present invention, when the operating valve is operated, the pilot oil is supplied to the second supply/discharge passage, and the first supply/discharge passage is connected to the tank. As a result, the pilot oil in the first pilot passage passes through the first throttle in the first passage, and is discharged to the tank through the first supply/discharge passage. The pilot oil in the first pilot passage is guided also to the first discharge passage. The first discharge passage is configured such that, when the operating amount of the operating tool is small and the pressure of the pilot oil is lower than the predetermined pressure, the first discharge passage is closed by the first pilot-to-open check valve so that the pilot oil will not flow out of the first discharge passage. Accordingly, when the operating amount of the operating tool is small, a flow of the pilot oil from the first pilot passage to the tank is limited by the first throttle, and thereby the switching speed of the switching valve can be limited. This makes it possible to reduce an impact shock in the actuator at start-up and stopping of the actuator.

When the operating amount of the operating tool increases and the pilot pressure supplied to the second supply/discharge passage has become higher than or equal to the predetermined pressure, the first discharge passage, which has been closed by the first pilot-to-open check valve, is opened, and thereby the pilot oil in the first pilot passage flows to the tank through the first discharge passage. That is, when the operating amount of the operating tool is large, the pilot oil in the first pilot passage flows to the tank through the first discharge passage, and thus limitation on the flow of the pilot oil to the tank is removed. In this manner, the influence of the viscosity of the pilot oil on the response speed of the actuator can be reduced, which makes it possible to operate the switching valve at a switching speed corresponding to the operating amount of the operating tool and increase the response speed of the actuator.

In the present invention having the above-described functions, the first pilot-to-open check valve is used. The first pilot-to-open check valve is capable of reducing pressure loss of the pilot oil that passes through the first pilot-to-open check valve without having an elongated shape. Therefore, the degree of freedom in the arrangement of the first pilot-to-open check valve in the valve block is high, and the degree of freedom in the shape of the cushion valve device can be made higher than the degree of freedom in the shape of spool-type cushion valve devices. Moreover, the contamination resistance of the first pilot-to-open check valve is higher than that of spool-type valves. This makes it possible to improve the contamination resistance of the cushion valve device.

In the above invention, the second passage preferably includes a second throttle. The valve block preferably includes a second discharge passage, the second discharge passage branching off from the second passage between the second throttle and the second pilot passage and connecting the second passage and the tank. Preferably, a first non-return valve portion is provided on a first parallel passage of the first passage, the first parallel passage connecting a portion preceding the first throttle and a portion subsequent to the first throttle. Preferably, a second non-return valve portion is provided on a second parallel passage of the second passage, the second parallel passage connecting a portion preceding the second throttle and a portion subsequent to the second throttle. Preferably, the first non-return valve portion allows the pilot oil to flow from the first supply/discharge passage to the first pilot passage, and blocks a flow of the pilot oil in an opposite direction. Preferably, the second non-return valve portion allows the pilot oil to flow from the second supply/discharge passage to the second pilot passage, and blocks a flow of the pilot oil in an opposite direction. The cushion valve device preferably includes a second pilot-to-open check valve configured to open the second discharge passage when the pressure of the pilot oil that flows through the first supply/discharge passage has become higher than or equal to a predetermined pressure, and close the second discharge passage when the pressure of the pilot oil that flows through the first supply/discharge passage has become lower than the predetermined pressure. Preferably, when the pressure of the pilot oil that flows through the first supply/discharge passage is lower than the predetermined pressure, the second pilot passage is connected to the tank via the second passage and the second supply/discharge passage.

According to the above configuration, whichever one of the first supply/discharge passage and the second supply/discharge passage is supplied with the pilot oil, the switching speed of the switching valve can be limited, or the limitation can be removed, in accordance with the operating amount of the operating tool. This makes it possible to reduce an impact shock in the actuator and improve the responsiveness of the actuator in relation to the actuator's bi-directional movements.

In the above invention, preferably, the first pilot-to-open check valve is a cartridge-type valve, and is configured to be detachably inserted in the first discharge passage, and the second pilot-to-open check valve is a cartridge-type valve, and is configured to be detachably inserted in the second discharge passage.

According to the above configuration, the first pilot-to-open check valve and the second pilot-to-open check valve can be readily attached to and detached from the valve block, and thus the first pilot-to-open check valve and the second pilot-to-open check valve can be readily replaced.

In the above invention, preferably, the first non-return valve portion and the first throttle are integrally formed as a cartridge-type valve and configured to be detachably inserted in the first passage, and the second non-return valve portion and the second throttle are integrally formed as a cartridge-type valve and configured to be detachably inserted in the second passage.

According to the above configuration, the non-return valves and the throttles can be readily attached to and detached from the valve block, and thus the non-return valves and the throttles can be readily replaced.

A multi-cushion valve unit according to the present invention includes a plurality of the cushion valve devices. The valve blocks of the plurality of the respective cushion valve devices are integrated together.

According to the above configuration, the cushion valve devices are integrated together, and thus space can be saved.

### Advantageous Effects of Invention

The present invention makes it possible to provide a cushion valve device with high contamination resistance and high degree of freedom in its shape.

The above object, other objects, features, and advantages of the present invention will be made clear by the following detailed description of preferred embodiments with reference to the accompanying drawings.

### BRIEF DESCRIPTION OF DRAWINGS

FIG. 1 is a schematic diagram showing a hydraulic drive circuit including a multi-cushion valve unit according to one embodiment of the present invention.

FIG. 2 is a hydraulic circuit diagram showing the hydraulic drive circuit of FIG. 1.

FIG. 3 is a perspective transparent view showing the configuration of the multi-cushion valve unit of FIG. 2.

FIG. 4 is a sectional view showing the configuration of a bypass-equipped non-return valve included in the multi-cushion valve unit of FIG. 3.

FIG. 5 is a sectional view showing the configuration of a pilot-to-open check valve included in the multi-cushion valve unit of FIG. 3.

FIG. 6 is a perspective transparent view showing the configuration of a multi-cushion valve unit according to another embodiment.

FIG. 7 is a perspective transparent view showing the configuration of a cushion valve device according to yet another embodiment.

FIG. 8 is a perspective view showing the configuration of a cushion valve device according to yet another embodiment.

### DESCRIPTION OF EMBODIMENTS

Hereinafter, a multi-cushion valve unit 1 according to one embodiment of the present invention (hereinafter, the multi-cushion valve unit may be simply referred to as a “cushion valve unit”) and a hydraulic drive circuit 2 including the multi-cushion valve unit 1 are described with reference to the drawings. It should be noted that directions mentioned in the embodiment, such as up-down and left-right directions, are used for the sake of convenience of the description, but do not suggest that the arrangement, orientation, and the like of components in the configurations of the cushion valve unit 1 and the hydraulic drive circuit 2 are limited to such directions. The configurations of the cushion valve unit 1 and the hydraulic drive circuit 2 described below are merely one embodiment of the present invention, and the present invention is not limited to the embodiment below. Additions, deletions, and modifications can be made to the embodiment without departing from the spirit of the present invention.

<Hydraulic Drive Circuit>

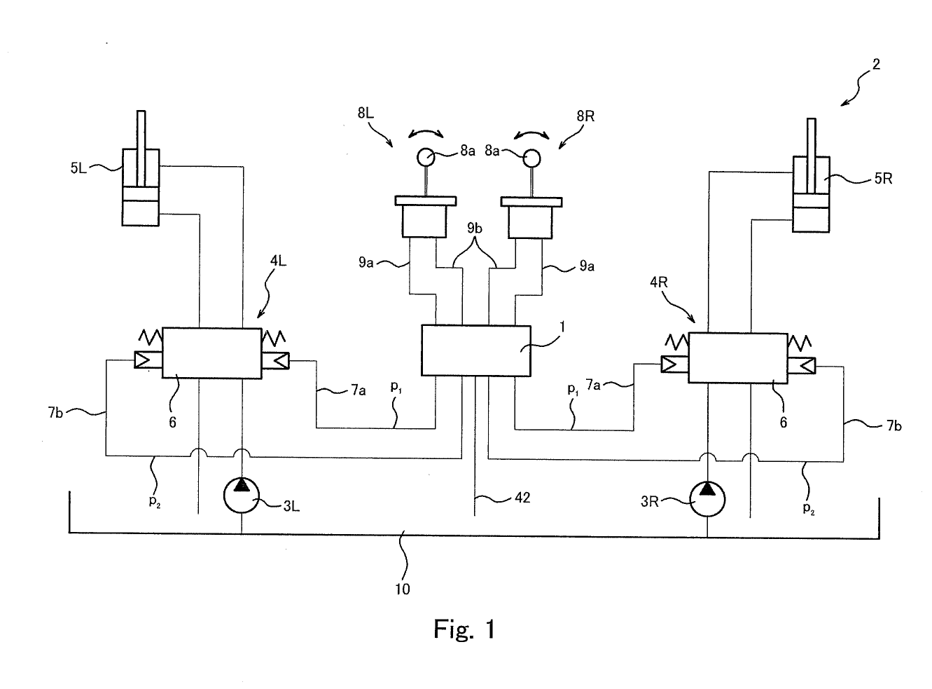

Construction machines such as a hydraulic excavator or hydraulic crane include a bucket, boom, etc. Such a construction machine performs various work by moving the bucket, boom, etc. The bucket and boom are driven by the hydraulic drive circuit 2 as shown in FIG. 1. The hydraulic drive circuit 2 includes two hydraulic pumps 3L and 3R. The hydraulic pumps 3L and 3R are configured to discharge hydraulic oil. Hydraulic cylinders 5L and 5R are connected to the hydraulic pumps 3L and 3R, respectively, via switching valves 4L and 4R. It should be noted that, for the purpose of simplifying the description, the present embodiment describes that only one hydraulic cylinder 5L is connected to the hydraulic pump 3L, and only one hydraulic cylinder 5R is connected to the hydraulic pump 3R. However, in reality, a plurality of hydraulic cylinders 5L are connected to the hydraulic pump 3L in a parallel manner, and a plurality of hydraulic cylinders 5R are connected to the hydraulic pump 3R in a parallel manner.

The hydraulic cylinders 5L and 5R, which are actuators, are configured to be driven to expand and contract by means of the hydraulic oil supplied from the hydraulic pumps 3L and 3R, respectively. As a result of the hydraulic cylinders being driven to expand and contract, the bucket and boom are moved. The switching valves 4L and 4R are configured to switch flow directions of the hydraulic oil flowing from the hydraulic pumps 3L and 3R to the hydraulic cylinders 5L and 5R, thereby causing the hydraulic cylinders 5L and 5R to expand, contract, or stop. Hereinafter, a brief description of the configurations of the switching valves 4L and 4R is given.

<Switching Valves>

Each of the switching valves 4L and 4R includes a spool 6, a first pilot passage 7a, and a second pilot passage 7b. The spool 6 is configured to receive a first pilot pressure p₁ of the first pilot passage 7a at one end of the spool 6 and a second pilot pressure p₂ of the second pilot passage 7b at the other end of the spool 6. The spool 6 is configured to move its position in accordance with a pressure difference between the first pilot pressure p₁ and the second pilot pressure p₂. Each of the switching valves 4L and 4R is configured to switch the flow direction and flow rate of the hydraulic oil in accordance with the position of the spool 6. A pilot operating valve 8L is connected to its corresponding first pilot passage 7a and second pilot passage 7b via the cushion valve unit 1. Similarly, a pilot operating valve 8R is connected to its corresponding first pilot passage 7a and second pilot passage 7b via the cushion valve unit 1.

<Pilot Operating Valves>

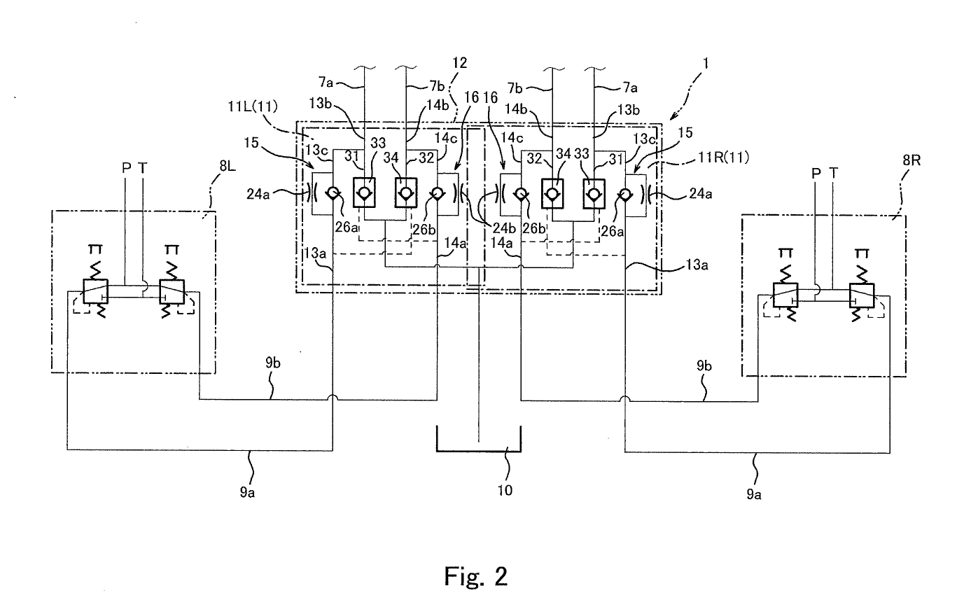

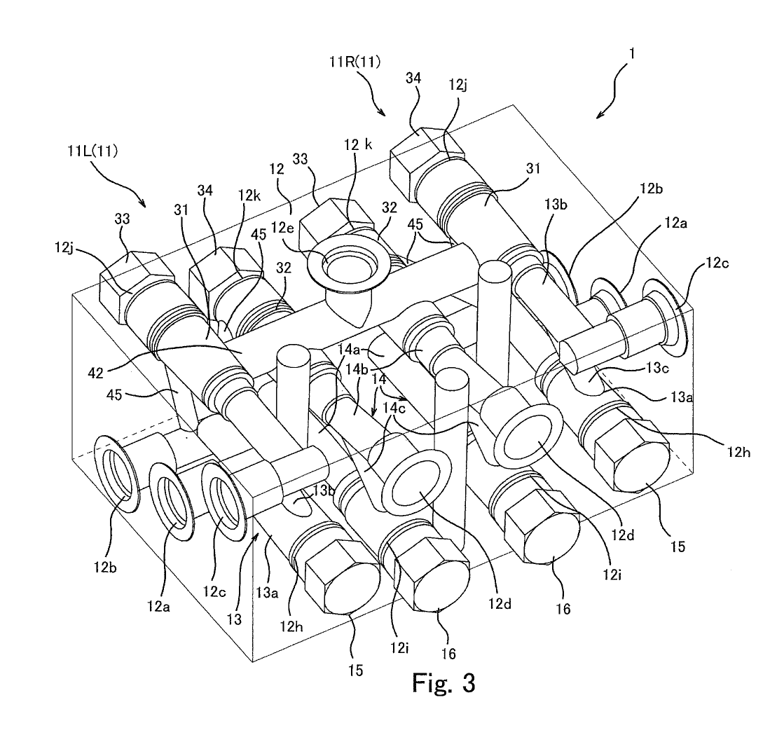

As shown in FIG. 2, each of the pilot operating valves 8L and 8R includes an operating tool 8a (e.g., an operating lever), which can be operated in one and the other predetermined directions. Each of the pilot operating valves 8L and 8R further includes a first supply/discharge passage 9a and a second supply/discharge passage 9b. The first supply/discharge passage 9a is connected to the first pilot passage 7a via the cushion valve unit 1, and the second supply/discharge passage 9b is connected to the second pilot passage 7b via the cushion valve unit 1. Each of the pilot operating valves 8L and 8R is connected to a pilot pump which is not shown (indicated by a reference sign P in FIG. 3) and to a tank 10 (indicated by a reference sign T in FIG. 3).

Each of the pilot operating valves 8L and 8R is configured to, when the operating tool 8a thereof is operated in the one predetermined direction, supply pilot oil to the second supply/discharge passage 9b with a hydraulic pressure corresponding to the operating amount of the operating tool 8a, and connect the first supply/discharge passage 9a to the tank. Further, each of the pilot operating valves 8L and 8R is configured to, when the operating tool 8a thereof is operated in the other predetermined direction, supply pilot oil to the first supply/discharge passage 9a with a hydraulic pressure corresponding to the operating amount of the operating tool 8a, and connect the second supply/discharge passage 9b to the tank. The pilot oil supplied to the second supply/discharge passage 9b is guided to the second pilot passage 7b through the cushion valve unit 1. Similarly, the pilot oil supplied to the first supply/discharge passage 9a is guided to the first pilot passage 7a through the cushion valve unit 1. It should be noted that cushion valve devices 11L and 11R provided herein need not be arranged in a symmetrical manner and need not be integrated together.

<Cushion Valve Unit>

The cushion valve unit 1, which is one embodiment of the present invention, is configured by integrating two cushion valve devices 11L and 11R together as shown in FIG. 3. The first cushion valve device 11L, i.e., one cushion valve device, is disposed between the switching valve 4L and the pilot operating valve 8L. The second cushion valve device 11R, i.e., the other cushion valve device, is disposed between the switching valve 4R and the pilot operating valve 8R. The two cushion valve devices 11L and 11R share a valve block 12, which is formed roughly in the shape of a rectangular parallelepiped, and are configured to be symmetrical with respect to a center plane of the valve block 12, the center plane extending in the width direction of the valve block 12. That is, the two cushion valve devices 11L and 11R have the same configuration. Therefore, in the description below, the configuration of only the one cushion valve device is described. Components of the other cushion valve device are denoted by reference signs that are the same as those used in the description of the configuration of the one cushion valve device, and the description of the other cushion valve device is omitted below.

<Cushion Valve Device>

As shown in FIG. 2 and FIG. 3, the cushion valve device 11 includes the valve block 12. First to third ports 12a to 12c are formed on the left side face of the valve block 12. A fourth port 12d is formed on the front face of the valve block 12. Further, a tank port 12e is formed on the upper face of the valve block 12. It should be noted that the tank port 12e is positioned at the center of the upper face of the valve block 12, and thus the single tank port 12e is formed for the two cushion valve devices 11. That is, the two cushion valve devices 11 share the single tank port 12e.

The first port 12a and the second port 12b are connected to the first supply/discharge passage 9a and the second supply/discharge passage 9b, respectively. The third port 12c and the fourth port 12d are connected to the first pilot passage 7a and the second pilot passage 7b, respectively. A first passage 13 connecting the first port 12a and the third port 12c, and a second passage 14 connecting the second port 12b and the fourth port 12d, are formed in the valve block 12. As shown in FIG. 3, when seen in right side view, these two passages 13 and 14 are roughly Z-shaped. The first and second ports 12a and 12b are connected to lower portions 13a and 14a of the passages 13 and 14, respectively. The third and fourth ports 12c and 12d are connected to upper portions 13b and 14b of the passages 13 and 14, respectively.

A first insertion opening 12h connected to the lower portion 13a of the first passage 13, and a second insertion opening 12i connected to the lower portion 14a of the second passage 14, are formed on the front face of the valve block 12. First and second bypass-equipped non-return valves 15 and 16 are inserted in the first and second insertion openings 12h and 12i, respectively. The inserted first and second bypass-equipped non-return valves 15 and 16 extend through the inside of the lower portions 13a and 14a, respectively.

### Bypass-Equipped Non-Return Valves

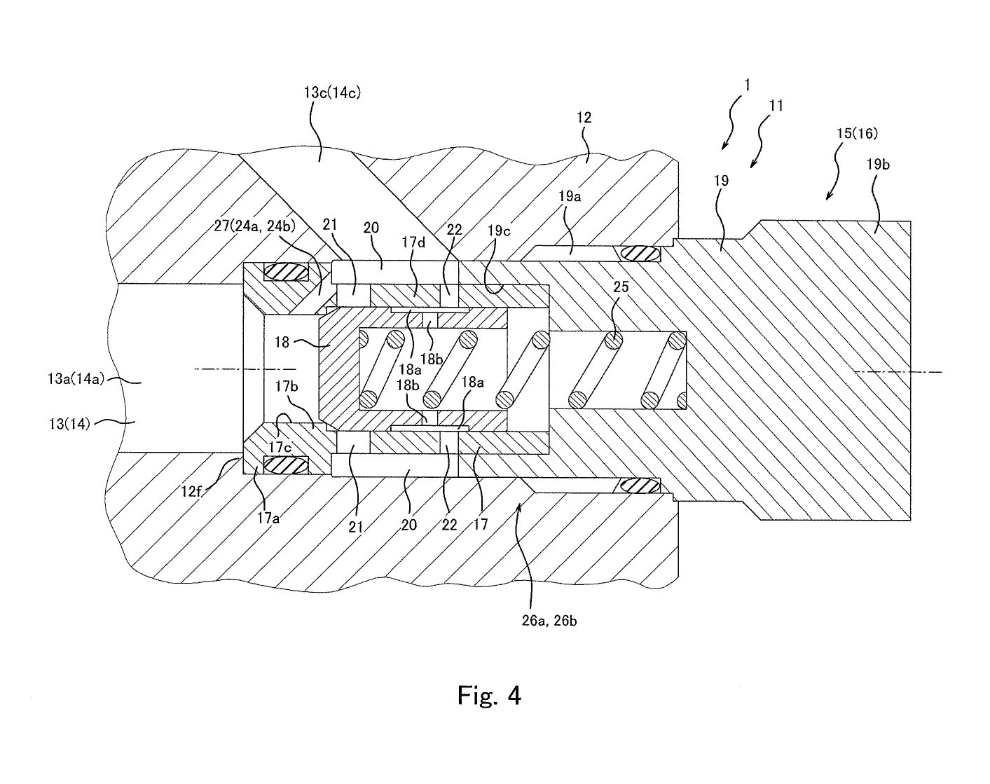

As shown in FIG. 4, fundamentally, the first bypass-equipped non-return valve (which may hereinafter be simply referred to as a “first non-return valve”) 15 includes a sleeve 17, a valve element 18, and a base 19. The sleeve 17 is roughly cylindrical and includes a flange portion 17a. The flange portion 17a extends fully circumferentially along the outer periphery of the sleeve 17 at the distal end side, and protrudes radially outward. The sleeve 17 is provided in the first passage 13 in a state where the flange portion 17a is in contact with an inner peripheral surface that defines the lower portion 13a of the first passage 13, such that space between the flange portion 17a and the inner peripheral surface is sealed. A step 12f is formed on the inner peripheral surface that defines the first passage 13, such that the diameter of the first passage 13 is greater at the sleeve 17 side. The distal end surface of the sleeve 17 is in contact with the step 12f. A valve seat portion 17b, which protrudes radially inward, is formed fully circumferentially along the inner periphery of the sleeve 17 at the distal end side. In the sleeve 17, the valve element 18 is provided in such a manner as to be seated on the valve seat portion 17b.

The valve element 18 is roughly in the shape of a bottomed cylinder, and is formed such that the distal end portion of the valve element 18 is tapered. The distal end portion of the valve element 18 is formed such that the distal end portion can be seated on the valve seat portion 17b, and when seated on the valve seat portion 17b, the distal end portion of the valve element 18 closes a valve hole 17c, which is an inner hole in the valve seat portion 17b. The valve element 18 is configured to be movable between a closing position and an opening position. At the closing position (see FIG. 4), the valve element 18 is seated on the valve seat portion 17b, thereby closing the valve hole 17c. At the opening position, the valve element 18 is away from the valve seat portion 17b, thereby opening the valve hole 17c. The base 19 is attached to the outer periphery of the sleeve 17 at the proximal end side of the sleeve 17, such that the base 19 blocks a proximal-end opening of the sleeve 17.

The base 19 is a component formed roughly in the shape of a bottomed cylinder. A male screw portion 19a is formed on the middle portion of the base 19, and the bottom portion of the base 19 has a hexagonal head 19b. The base 19 with such a shape is inserted in the first passage 13 and screwed in the valve block 12, such that the head 19b is in a state of protruding from the first insertion opening 12h. In the base 19 screwed in such a manner, the proximal end portion of the sleeve 17 is inserted in a distal-end inner hole 19c of the base 19, and thus the inner hole 19c and the step 12f of the valve block 12 sandwich the sleeve 17.

Annular space 20, which is roughly ring-shaped, is formed between the distal end portion of the base 19 and the flange portion 17a of the sleeve 17. The annular space 20 is connected to a middle portion 13c of the first passage 13, the middle portion 13c connecting the lower portion 13a and the upper portion 13b. The annular space 20 is positioned outside the middle portion of the sleeve 17. A main communication passage 21 and a pilot passage 22 are formed in the middle portion 17d of the sleeve 17. The main communication passage 21 and the pilot passage 22 radially extend through the sleeve 17, and connect the inside of the sleeve 17 and the annular space 20. The main communication passage 21 is formed such that the main communication passage 21 is closer to the distal end of the sleeve 17 than the pilot passage 22, and is configured to connect to the valve hole 17c when the valve element 18 is at the opening position.

The pilot passage 22 is such that its inner openings are positioned so as to face the middle portion of the outer periphery of the valve element 18. In the middle portion of the outer periphery of the valve element 18, an annular groove 18a, which extends fully circumferentially along the middle portion, is formed. The annular groove 18a has a predetermined width in the axial direction of the valve element 18, and is formed such that even if the valve element 18 moves between the closing position and the opening position, the pilot passage 22 is connected to the annular groove 18a. The annular groove 18a formed in such a manner is connected to the inside of the valve element 18 via a plurality of communication holes 18b. That is, regardless of the position of the valve element 18, the inside of the valve element 18 and the middle portion 13c of the first passage 13 are always connected to each other via the annular space 20, the pilot passage 22, the annular groove 18a, and the communication holes 18b, so that the pilot oil that is guided to the middle portion 13c of the first passage 13 is guided into the valve element 18.

The valve element 18 is configured to receive acting force from the pilot oil that is guided into the valve element 18, the acting force being in a direction toward the closing position (hereinafter, the direction toward the closing position may simply be referred to as a “closing position direction”), and also receive acting force from the pilot oil that is guided into the valve hole 17c, the acting force being in a direction toward the opening position (hereinafter, the direction toward the opening position may simply be referred to as a “opening position direction”). A spring member 25 is provided between the base 19 and the valve element 18, such that the valve element 18 is in a state of receiving, from the spring member 25, urging force urging the valve element 18 in the closing position direction.

In the bypass-equipped non-return valve 15 with the above-described configuration, when the pilot oil is guided from the first supply/discharge passage 9a to the lower portion 13a of the first passage 13, the valve element 18 is pushed up by the pilot oil and thereby moved in the opening position direction. As a result of the valve element 18 being moved in the opening position direction, the valve hole 17c and the main communication passage 21 come into communication with each other, and thereby the lower portion 13a and the middle portion 13c of the first passage 13 are connected to each other. In this manner, the first passage 13 is opened and the pilot oil is allowed to flow from the first supply/discharge passage 9a to the first pilot passage 7a. On the other hand, when the lower portion 13a is connected to the tank 10 via the first supply/discharge passage 9a, the valve element 18 is pushed down by the spring member 25 and the pilot oil that is guided into the valve element 18, and thereby moved in the closing position direction. As a result of the valve element 18 being moved in the closing position direction, the valve hole 17c is closed, and the communication between the lower portion 13a and the middle portion 13c of the first passage 13 is blocked. In this manner, the first passage 13 is closed and the pilot oil is prevented from flowing from the first pilot passage 7a to the first supply/discharge passage 9a.

In the present embodiment, the first non-return valve 15 thus includes a first non-return valve portion 26a, which allows the pilot oil to flow from the first supply/discharge passage 9a to the first pilot passage 7a and prevents the flow of the pilot oil in the opposite direction in the above-described manner. In addition, the first non-return valve 15 includes a bypass passage 27, which connects a portion preceding the first non-return valve portion 26a and a portion subsequent to the first non-return valve portion 26a (i.e., connects the lower portion 13a and the middle portion 13c of the first passage 13) in a manner to bypass the first non-return valve portion 26a. The bypass passage 27 is formed in the distal end portion of the sleeve 17, and connects the valve hole 17c and the annular space 20. The passage cross-sectional area of the bypass passage 27 is less than that of the valve hole 17c and that of the annular space 20, and the bypass passage 27 serves as a first throttle 24a of the first passage 13. That is, the first non-return valve portion 26a is provided on a first parallel passage, which connects a portion preceding the first throttle 24a and a portion subsequent to the first throttle 24a. The first non-return valve 15 with such a configuration allows, by means of the bypass passage 27, the pilot oil to flow from the first pilot passage 7a to the first supply/discharge passage 9a even when the first passage 13 is in a closed state.

The first non-return valve 15 functioning in the above-described manner is a so-called cartridge-type non-return valve, which is assembled in advance. That is, before the first non-return valve 15 is attached to the valve block 12, the valve element 18 is inserted in the sleeve 17, and the base 19 is attached to the outside of the proximal end portion of the sleeve 17. The first non-return valve 15 in such an assembled state is inserted into the first insertion opening 12h, and the base 19 is screwed into the valve block 12 by rotating the head 19b. In this manner, the first non-return valve 15 is attached. At the time of replacing the first non-return valve 15, the first non-return valve 15 can be detached from the valve block 12 by rotating the base 19. Thus, the first non-return valve 15 is configured such that the attachment to and detachment from the valve block 12 can be readily performed, and the first non-return valve 15 can be readily replaced when, for example, it has broken down.

The second bypass-equipped non-return valve (which may hereinafter be simply referred to as a “second non-return valve”) 16 is configured in the same manner as that of the first non-return valve 15. That is, the second bypass-equipped non-return valve 16 includes a second non-return valve portion 26b and the bypass passage 27. The second non-return valve portion 26b is provided on a second parallel passage, which connects a portion preceding a second throttle 24b and a portion subsequent to the second throttle 24b. The second non-return valve 16 with such a configuration is also a cartridge-type non-return valve. In a state where the valve element 18 is inserted in the sleeve 17 and the base 19 is attached to the outside of the proximal end portion of the sleeve 17, the second non-return valve 16 is inserted into the second insertion opening 12i and the base 19 is screwed into the valve block 12. In this manner, the second non-return valve 16 is attached.

The valve hole 17c of the second non-return valve 16 is connected to the second supply/discharge passage 9b. When the pilot oil is guided from the second supply/discharge passage 9b to the lower portion 14a of the second passage 14, the valve element 18 is pushed up by the pilot oil and thereby moved in the opening position direction. As a result, the second passage 14 is opened and the pilot oil is allowed to flow from the second supply/discharge passage 9b to the second pilot passage 7b. On the other hand, when the lower portion 14a is connected to the tank 10 via the second supply/discharge passage 9b, the valve element 18 is pushed down by the spring member 25 and the pilot oil that is guided into the valve element 18, and thereby moved in the closing position direction. As a result, the second passage 14 is closed and the pilot oil is prevented from flowing from the second pilot passage 7b to the second supply/discharge passage 9b. The second non-return valve 16 allows, by means of the bypass passage 27 which serves as the second throttle 24b of the second passage 14, the pilot oil to flow from the second pilot passage 7b to the second supply/discharge passage 9b even when the second passage 14 is in a closed state.

The first non-return valve 15 and the second non-return valve 16 with the above-described configurations are provided on the front face of the valve block 12 as previously described. Meanwhile, a third insertion opening 12j and a fourth insertion opening 12k are formed on the rear face of the valve block 12, and a first discharge passage 31 and a second discharge passage 32 are formed inside the valve block 12. The first discharge passage 31 and the second discharge passage 32 extend in the front-rear direction, and are connected to the upper portion 13b of the first passage 13 and the upper portion 14b of the second passage 14, respectively. The third insertion opening 12j is connected to the upper portion 13b of the first passage 13 via the first discharge passage 31, and the fourth insertion opening 12k is connected to the upper portion 14b of the second passage 14 via the second discharge passage 32. First and second pilot-to-open check valves 33 and 34 are inserted in the third and fourth insertion openings 12j and 12k, respectively. The first and second pilot-to-open check valves 33 and 34 thus inserted extend through the inside of the first and second discharge passages 31 and 32, respectively.

### Pilot-To-Open Check Valves

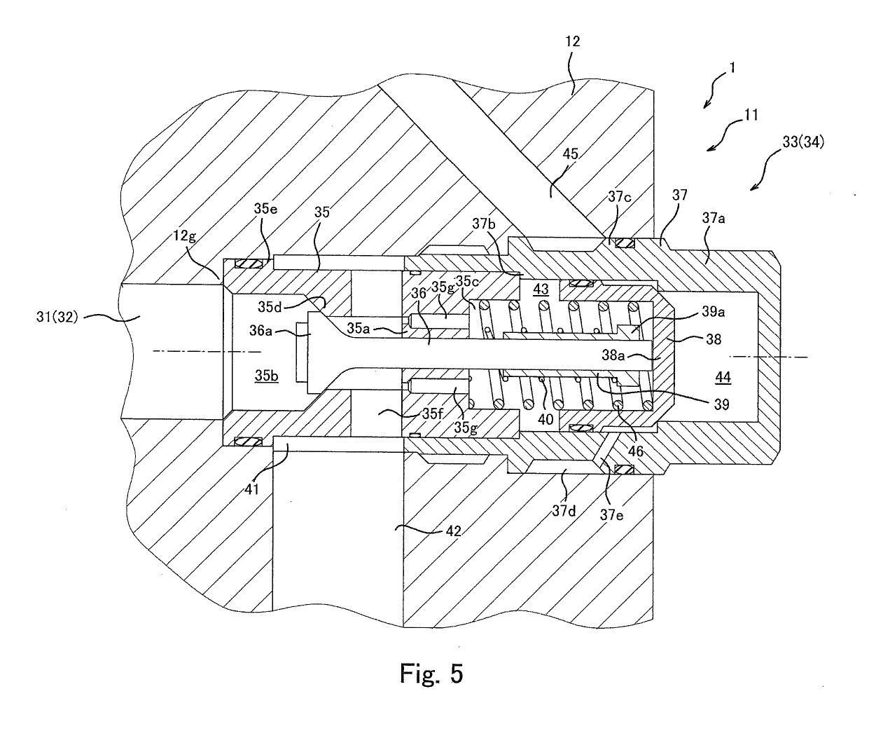

As shown in FIG. 5, fundamentally, the first pilot-to-open check valve (which may hereinafter be simply referred to as a “first check valve”) 33 includes a sleeve 35, a poppet valve element 36, a casing 37, and a piston 38. The sleeve 35 is roughly cylindrical and includes a holder 35a, which is in the shape of an inward flange. The holder 35a protrudes radially inward and extends fully circumferentially along the inner periphery of the middle portion of the sleeve 35. The holder 35a divides an inner hole of the sleeve 35 into a distal-end-side valve passage 35b and spring bearing space 35c. The poppet valve element 36 is inserted in an inner hole of the holder 35a.

The poppet valve element 36, which is a main valve element, is roughly columnar and its distal end portion has an inverted-tapered pileus-shaped portion 36a, such that the closer to the distal end of the poppet valve element 36, the more outwardly extending the pileus-shaped portion 36a is. In the sleeve 35, the pileus-shaped portion 36a is disposed closer to the distal end of the sleeve 35 than the holder 35a. On the inner periphery of the sleeve 35, a valve seat portion 35d is formed, facing the outer edge of a proximal-end-side surface (i.e., a tapered surface) of the pileus-shaped portion 36a. The valve passage 35b is closed when the pileus-shaped portion 36a of the poppet valve element 36 is seated on the valve seat portion 35d (i.e., when the pileus-shaped portion 36a is positioned at a closing position) (see FIG. 5). The valve passage 35b is opened when the pileus-shaped portion 36a moves away from the valve seat portion 35d (i.e., when the pileus-shaped portion 36a is positioned at an opening position).

A spring bearing member 39, which is roughly cylindrical, is attached to the outside of the proximal end portion of the poppet valve element 36. The spring bearing member 39 includes a flange portion 39a, which is a fully circumferentially extending portion. A poppet spring member 40 is provided between the flange portion 39a and the holder 35a, in such a manner that the poppet spring member 40 is attached outside the poppet valve element 36. The poppet spring member 40 is a so-called compression coil spring, and is in a state of urging the poppet valve element 36 toward the closing position via the spring bearing member 39.

The sleeve 35 includes a flange portion 35e, which protrudes radially outward and extends fully circumferentially along the outer periphery of the sleeve 35 at the distal end side. The flange portion 35e is provided in the first discharge passage 31 such that the flange portion 35e is fitted, in a sealing manner, to an inner peripheral surface that defines the upper portion 13b. The valve passage 35b is connected to the first discharge passage 31. A step 12g is formed on an inner peripheral surface that defines the first discharge passage 31. Owing to the step 12g, the diameter of the first discharge passage 31 at the third insertion opening 12j side is greater than the diameter of the remaining portion of the first discharge passage 31. The distal end of the flange portion 35e of the sleeve 35 is in contact with the step 12g. The casing 37 is attached to the outside of the proximal end portion of the sleeve 35 provided in the above-described manner in the first discharge passage 31.

The casing 37 is roughly in the shape of a bottomed cylinder, and the bottom portion of the casing 37 has a hexagonal head 37a. The casing 37 is inserted in the first discharge passage 31 and the distal end portion of the casing 37 is screwed in the valve block 12, such that the head 37a is in a state of protruding from the third insertion opening 12j. On the inner peripheral surface of the casing 37, a step 37b is formed at a position relatively closer to an opening of the casing 37. The diameter of the inner peripheral surface of the casing 37 is greater at a portion that is closer to the opening than the step 37b. The step 37b of the casing 37 is in contact with the outer edge of the proximal end of the sleeve 35, thereby sandwiching the sleeve 35 with the step 12g, i.e., sandwiching the sleeve 35 between the two steps.

Annular communication space 41 positioned between the flange portion 35e and the distal end portion of the casing 37 is formed outside the middle portion of the sleeve 35. A plurality of communication holes 35f are formed in the middle portion of the sleeve 35. The communication holes 35f connect the valve passage 35b and the communication space 41. The communication space 41 is connected to a tank passage 42. It should be noted that, for the sake of convenience of the description, FIG. 5 shows the tank passage 42 being in a position that is different from an actual position of the tank passage 42. The tank passage 42 is formed to extend in the left-right direction of the valve block 12, and is connected to the tank port 12e. Accordingly, when the valve passage 35b is opened, the pilot oil is guided to the tank 10 through the communication holes 35f, the communication space 41, and the tank passage 42.

The piston 38 is provided in the casing 37. The piston 38 is a driven unit formed roughly in the shape of a bottomed cylinder. The piston 38 is inserted in the casing 37 such that the piston 38 is sealed to the inner peripheral surface of the casing 37. The piston 38 has an opening facing the sleeve 35. The proximal end portion of the poppet valve element 36 is positioned in the opening of the piston 38. The piston 38 has a bottom portion 38a facing the proximal end portion of the poppet valve element 36. A check spring member 46 is disposed between the bottom portion 38a and the holder 35a, such that the check spring member 46 is attached outside the poppet valve element 36. The check spring member 46 is in a state of urging the piston 38 in a direction away from the poppet valve element 36. The piston 38 divides the inside of the casing 37 into a back pressure chamber 43 and a pilot pressure chamber 44.

The back pressure chamber 43 is positioned at the holder 35a side, and is connected to the valve passage 35b via a plurality of communication passages 35g formed in the holder 35a. Meanwhile, the pilot pressure chamber 44 is positioned at the bottom side of the casing 37. On the middle portion of the outer periphery of the casing 37, a flange portion 37c, which protrudes radially outward and which extends fully circumferentially along the middle portion of the outer periphery of the casing 37, is formed. In the outer periphery of the flange portion 37c, an annular groove 37d extending fully circumferentially along the outer periphery of the flange portion 37c is formed. A communication passage 37e is formed in the casing 37. The annular groove 37d is connected to the pilot pressure chamber 44 via the communication passage 37e. Further, the annular groove 37d is connected to a pilot pressure guiding passage 45 formed in the valve block 12. The pilot pressure guiding passage 45 is connected to the lower portion 14a of the second passage 14. Therefore, the pilot oil that flows through the second supply/discharge passage 9b is guided to the pilot pressure chamber 44 through the first passage 13 and the pilot pressure guiding passage 45.

In the first check valve 33 with the above-described configuration, the pileus-shaped portion 36a of the poppet valve element 36 receives pilot pressure directed toward the closing position from the pilot oil that is guided to the first discharge passage 31. On the other hand, the piston 38 receives pilot pressure from the pilot oil that is guided to the pilot pressure chamber 44, the pilot pressure resisting against the urging force of the check spring member 46. When the pressure in the second supply/discharge passage 9b is lower than a predetermined pressure, the acting force of the pilot oil acting on the piston 38 is less than the urging force of the check spring member 46, and thereby the piston 38 is positioned away from the poppet valve element 36. Accordingly, the pileus-shaped portion 36a of the poppet valve element 36 receiving the pilot pressure directed toward the closing position is seated on the valve seat portion 35d, and thereby the first discharge passage 31 is in a closed state.

When the pressure in the second supply/discharge passage 9b has become higher than or equal to the predetermined pressure, the acting force of the pilot oil acting on the piston 38 becomes greater than the urging force of the check spring member 46. As a result, the piston 38 moves toward the poppet valve element 36. The piston 38 eventually comes into contact with the poppet valve element 36, and thus pushes the poppet valve element 36 toward the opening position. The poppet valve element 36 thus pushed moves to the opening position, and thereby the pileus-shaped portion 36a of the poppet valve element 36 moves away from the valve seat portion 35d. In this manner, the valve passage 35b is opened. That is, the first discharge passage 31 is opened. As a result of the first discharge passage 31 being opened, the pilot oil that flows through the upper portion 13b of the first passage 13 is guided to the tank through the first discharge passage 31 and the tank passage 42. Then, when the pressure in the second supply/discharge passage 9b has become lower than the predetermined pressure, the piston 38 is pushed by force such as the urging force of the check spring member 46, and is thereby returned to the original position. In accordance with such movement of the piston 38, the poppet valve element 36 moves toward the closing position. Then, the poppet valve element 36 is seated on the valve seat portion 35d, so that the first discharge passage 31 is closed.

The first check valve 33 functioning in the above-described manner is a so-called cartridge-type check valve, which is assembled in advance. That is, before the first check valve 33 is attached to the valve block 12, the poppet valve element 36 is inserted in the holder 35a of the sleeve 35, and the casing 37 in which the piston 38 is disposed is attached to the outside of the proximal end portion of the sleeve 35. The first check valve 33 in such an assembled state is inserted into the third insertion opening 12j, and the casing 37 is screwed into the valve block 12 by rotating the head 37a. In this manner, the first check valve 33 is attached. At the time of replacing the first check valve 33, the first check valve 33 can be detached from the valve block 12 by rotating the head 37a in a direction inverse to the rotation direction at the time of attaching the first check valve 33. Thus, the first check valve 33 is configured such that the attachment to and detachment from the valve block 12 can be readily performed, and the first check valve 33 can be readily replaced when, for example, it has broken down.

The second pilot-to-open check valve (which may hereinafter be simply referred to as a “second check valve”) 34 is configured in the same manner as that of the first check valve 33, and is a cartridge-type check valve. That is, also in the second check valve 34, the poppet valve element 36 is inserted in the holder 35a of the sleeve 35, and the casing 37 in which the piston 38 is disposed is attached to the outside of the proximal end portion of the sleeve 35. The second check valve 34 in such a state is inserted into the fourth insertion opening 12k, and the casing 37 is screwed into the valve block 12. In this manner, the second check valve 34 is attached. The valve passage 35b is connected to the second discharge passage 32 and the tank passage 42, and the pilot pressure guiding passage 45 is connected to the first supply/discharge passage 9a via the lower portion 13a of the first passage 13b.

In the second check valve 34, the valve passage 35b is connected to the second discharge passage 32, and the poppet valve element 36 is pushed by the pilot oil that is guided to the second discharge passage 32. Accordingly, the pileus-shaped portion 36a of the poppet valve element 36 is seated on the valve seat portion 35d, and thereby the second discharge passage 32 is in a closed state. When the pressure in the first supply/discharge passage 9a has become higher than or equal to a predetermined pressure, the piston 38 is pushed and moved toward the poppet valve element 36. The piston 38 eventually comes into contact with the poppet valve element 36, and thus pushes the poppet valve element 36 toward the opening position. The poppet valve element 36 thus pushed moves to the opening position, and thereby the pileus-shaped portion 36a of the poppet valve element 36 moves away from the valve seat portion 35d. In this manner, the second discharge passage 32 is opened. As a result, the pilot oil that flows through the upper portion 14b of the second passage 14 is guided to the tank through the second discharge passage 32 and the tank passage 42. When the pressure in the first supply/discharge passage 9a has become lower than the predetermined pressure, the piston 38 is returned to the original position by the check spring member 46. In accordance with such movement of the piston 38, the poppet valve element 36 moves toward the closing position. Then, the poppet valve element 36 is seated on the valve seat portion 35d, so that the second discharge passage 32 is closed.

<Function of Cushion Valve Device>

Hereinafter, functions of the above-described cushion valve device 11 are described. When the operating tool 8a of the operating valve 8L is operated in the one predetermined direction, the pilot oil is supplied to the second supply/discharge passage 9b, and the supplied pilot oil is guided to the second non-return valve 16 through the second port 12b and the lower portion 14a of the second passage 14. The pilot oil guided to the second non-return valve 16 pushes the valve element 18 in the opening position direction, opens the second passage 14, and flows to a middle portion 14b of the second passage 14. The pilot oil is further guided to the second pilot passage 7b through the lower portion 14a of the second passage 14 and the fourth port 12d. At the time, the second discharge passage 32 is in a state of being closed by the poppet valve element 36. Accordingly, the pilot oil is prevented from being discharged to the tank 10 through the first discharge passage 31 and the tank passage 42. The pilot oil guided to the second pilot passage 7b pushes and moves the spool 6 of the switching valve 4L.

Meanwhile, the first supply/discharge passage 9a is connected to the tank 10, and the pilot oil in the first pilot passage 7a is guided to the upper portion 13b of the first passage 13. The pilot oil guided to the upper portion 13b passes through the middle portion 13c of the first passage 13, and is guided to the first non-return valve 15. In the first non-return valve 15, when the pilot oil is thus guided from the first pilot passage 7a to the middle portion 13c, the valve element 18 moves to the closing position, so that the first passage 13 is closed. Consequently, the pilot oil in the middle portion 13c does not pass through the non-return valve portion 26a, but flows through the bypass passage 27 to the lower portion 13a, and the pilot oil is further guided to the tank 10 through the first port 12a and the first supply/discharge passage 9a.

The pilot oil that has been guided to the upper portion 13b is guided to the first check valve 33 through the first discharge passage 31. As previously described, the first check valve 33 is configured to operate in accordance with the hydraulic pressure p₂ in the second supply/discharge passage 9b. The hydraulic pressure p₂ changes in accordance with the operating amount of the operating tool 8a of the operating valve 8L. That is, the first check valve 33 is configured to operate in accordance with the operating amount of the operating tool 8a of the operating valve 8L. When the operating amount is less than a predetermined amount, the poppet valve element 36 is seated on the valve seat portion 35d, and the first discharge passage 31 is in a closed state. Accordingly, the pilot oil that is guided to the first discharge passage 31 is stopped by the first check valve 33. Therefore, when the operating amount of the operating tool 8a is less than the predetermined amount, the pilot oil in the first pilot passage 7a is guided to the first supply/discharge passage 9a through the bypass passage 27, and is further guided to the tank 10. As previously described, the bypass passage 27 serves as the first throttle 24a, and the flow rate of the pilot oil that flows through the first passage 13 is limited by the first throttle 24a. That is, the flow rate of the pilot oil that returns to the tank 10 from the first pilot passage 7a can be limited, and the switching speed of the switching valve 4L can be limited. Consequently, an impact shock occurring in the hydraulic cylinder 5L can be reduced.

On the other hand, when the operating amount of the operating tool 8a of the operating valve 8L is greater than or equal to the predetermined amount, the internal pressure of the pilot pressure chamber 44 is higher than or equal to a predetermined pressure. Accordingly, the poppet valve element 36 is pushed via the piston 38, and moves away from the valve seat portion 35d, so that the first discharge passage 31 is opened. As a result, the pilot oil that has been guided to the upper portion 13b of the first passage 13 is guided to the tank 10 through the bypass passage 27. The pilot oil that has been guided to the upper portion 13b of the first passage 13 is also guided to the tank passage 42 through the first check valve 33, and further guided to the tank 10 through the tank port 12e. In this manner, limitation on the flow rate of the pilot oil that flows from the first pilot passage 7a to the tank 10 is removed. Therefore, the influence of the viscosity of the pilot oil on the response speed of the hydraulic cylinder 5L can be reduced, which makes it possible to operate the switching valve 4L at a switching speed corresponding to the operating amount of the operating tool 8a and increase the response speed of the hydraulic cylinder 5L.

Here, a brief description is given of a case where the operating tool 8a of the operating valve 8L is operated in the other predetermined direction. When the operating tool 8a of the operating valve 8L is operated in the other predetermined direction, the pilot oil is supplied to the first supply/discharge passage 9a. The supplied pilot oil pushes the valve element 18 of the first non-return valve 15 to open the first passage 13, and is guided to the first pilot passage 7a through the first passage 13. Meanwhile, when the operating tool 8a of the operating valve 8L is operated in the other predetermined direction, the second supply/discharge passage 9b becomes connected to the tank 10, and the pilot oil in the second pilot passage 7b flows to the tank 10 through the bypass passage 27 of the second non-return valve 16.

When the operating amount of the operating tool 8a is less than or equal to the predetermined amount, since the second discharge passage 32 is in a state of being closed by the second check valve 34, the pilot oil in the second pilot passage 7b is guided to the tank 10 through the bypass passage 27. Therefore, the flow rate of the pilot oil that returns to the tank 10 is limited by the second throttle 24b. In this manner, the switching speed of the switching valve 4L can be limited, and an impact shock occurring in the hydraulic cylinder 5L can be reduced.

On the other hand, when the operating amount of the operating tool 8a of the operating valve 8L is greater than or equal to the predetermined amount, the second check valve 34 is operated and the second discharge passage 32 is opened, so that the pilot oil in the second pilot passage 7b is guided to the tank 10 through the bypass passage 27, and also, the pilot oil in the second pilot passage 7b flows to the tank 10 through the second check valve 34, the tank passage 42, and the tank port 12e. Accordingly, limitation on the flow rate of the pilot oil that flows from the second pilot passage 7b to the tank 10 is removed, which makes it possible to operate the switching valve 4L at a switching speed corresponding to the operating amount of the operating tool 8a. Thus, as with the case where the operating tool 8a is operated in the one predetermined direction, the response speed of the hydraulic cylinder 5L can be improved.

Similarly, in cases where the operating tool 8a of the operating valve 8R is operated in the one and the other predetermined directions, an impact shock occurring in the hydraulic cylinder 5R can be reduced and the response speed of the hydraulic cylinder 5R can be improved although the description of these cases is omitted.

In the cushion valve device 11 with the above-described configuration, the first and second poppet-type check valves 33 and 34 are used in place of conventional spool-type switching valves. Unlike spool valves, in the case of the first and second check valves 33 and 34, the pilot oil is not actively flowed between the poppet valve element 36 and the sleeve 35. Accordingly, a risk that contaminants contained in the pilot oil become caught between the poppet valve element 36 and the sleeve 35 and thereby the poppet valve element 36 becomes unable to move is eliminated. As a result, high contamination resistance is obtained. Thus, by using the first and second check valves 33 and 34, the cushion valve device 11 with high contamination resistance can be manufactured.

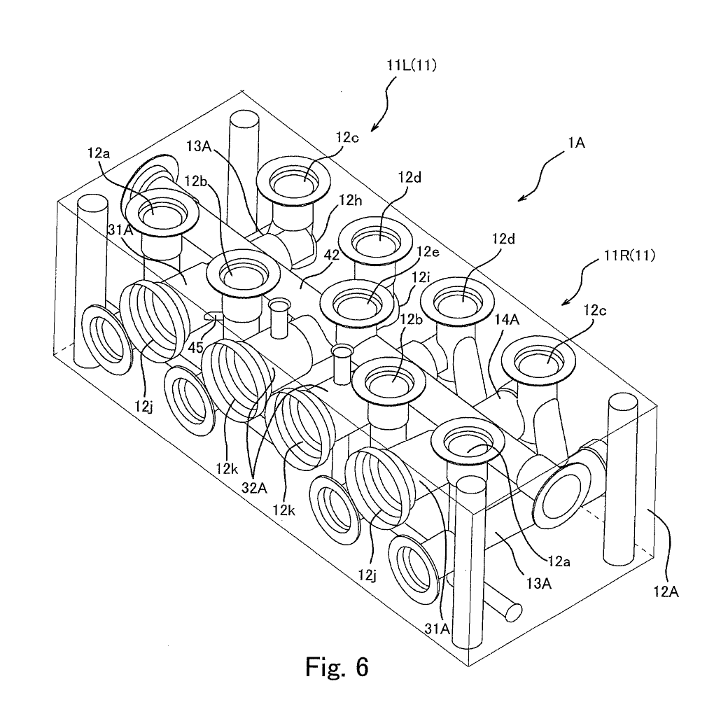

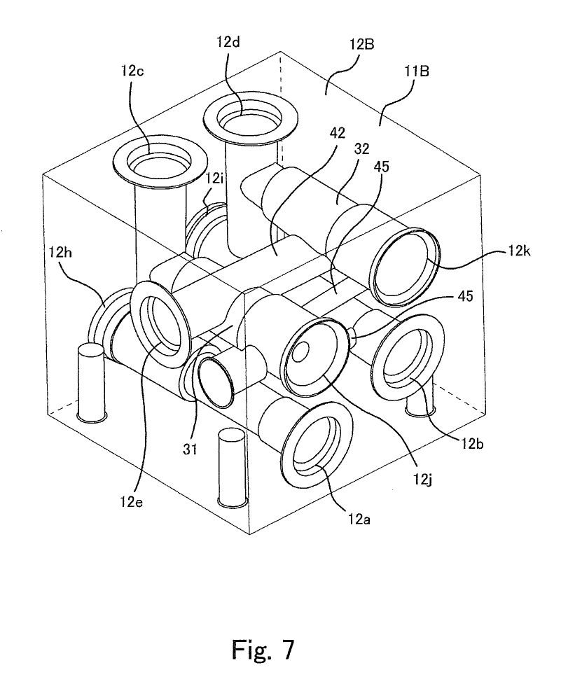

A switching valve is configured to reduce pressure loss of the valve by increasing the degree of opening of the valve by increasing the spool stroke. Thus, the length of the switching valve in the axial direction is extended in order to reduce the pressure loss. On the other hand, the first and second check valves 33 and 34 are capable of reducing pressure loss of the valves by increasing the diameter of the valve passage 35b. Therefore, pressure loss of the pilot oil that passes through the first and second check valves 33 and 34 can be reduced without forming the poppet valve element 36 and the piston 38 in an elongated shape. Consequently, the first and second check valves 33 and 34 can be formed in such a shape that the length of the check valves 33 and 34 in the axial direction is shorter than the length of conventional switching valves in the axial direction. As a result, the degree of freedom in the arrangement of the first and second check valves 33 and 34 in the valve block 12 is increased, and also, the degree of freedom in the arrangement of the other components (e.g., the first and second non-return valves 15 and 16) is increased. Therefore, the external shape of the valve block 12 can be designed freely, and thus the cushion valve device 11 with a high degree of freedom in terms of the shape can be manufactured. Hereinafter, a cushion valve unit 1A and cushion valve devices 11B and 11C with different external shapes according to another embodiment, which are manufactured incorporating the above-described advantages, are described with reference to FIGS. 6 to 8. It should be noted that, in FIG. 6 to FIG. 8, the first non-return valve 15, the second non-return valve 16, the first check valve 33, and the second check valve 34 are omitted.

### Description of Another Embodiment

The configurations of the cushion valve unit 1A and the cushion valve devices 11B and 11C of another embodiment are similar to the configurations of the cushion valve unit 1 and the cushion valve device 11 of the above-described embodiment. Therefore, the description below describes differences of the configurations of cushion valve units 1A to 1C of the other embodiment from the configuration of the cushion valve unit 1 of the above-described embodiment, and the description of configurational features that are the same between the other embodiment and the above-described embodiment is omitted.

The cushion valve unit 1A is configured such that the cushion valve devices 11L and 11R are integrated together, and the first insertion openings 12h and the second insertion openings 12i of the cushion valve devices 11L and 11R, i.e., four insertion openings 12h, 12h, 12i, 12i, are formed on the rear face of a valve block 12A, and are arranged in a line in the left-right direction. The third insertion openings 12j and the fourth insertion openings 12k of the cushion valve devices 11L and 11R, i.e., four insertion openings 12j, 12j, 12k, 12k, are formed on the front face of the valve block 12A, and are arranged in a line in the left-right direction. The first ports 12a and the second ports 12b of the cushion valve devices 11L and 11R, i.e., four ports 12a, 12a, 12b, 12b, are formed on the front side of the upper face of the valve block 12A, and are arranged in a line in the left-right direction. The third ports 12c and the fourth ports 12d of the cushion valve devices 11L and 11R, i.e., four ports 12c, 12c, 12d, 12d, are formed on the rear side of the upper face of the valve block 12A, and are arranged in a line in the left-right direction. The tank port 12e is formed on the upper face of the valve block 12A, such that the tank port 12e is positioned at the center of the upper face in the front-rear and left-right directions.

Inside the valve block 12A, various passages such as first passages 13A, second passages 14A, first discharge passages 31A, second discharge passages 32A, and the pilot pressure guiding passages 45 are formed in a manner to connect the ports 12a to 12e and the insertion openings 12h to 12k. By arranging the ports 12a to 12e and the insertion openings 12h to 12k in lines in this manner, the valve block 12A can be formed to be elongated in the left-right direction and can be formed roughly in the shape of a rectangular parallelepiped. This makes it possible to manufacture the cushion valve unit 1A, which has a low height and which is elongated in the left-right direction and roughly in the shape of a rectangular parallelepiped.

The cushion valve device 11B itself is formed as a single unit, and a valve block 12B therein is formed roughly in the shape of a cube. Specifically, the first and second ports 12a and 12b and the first and second insertion openings 12h and 12i are formed on the front face of the valve block 12B. The third and fourth ports 12c and 12d are formed on the upper face of the valve block 12B. The third and fourth insertion openings 12j and 12k are formed on the rear face of the valve block 12B. The tank port 12e is formed on the left side face of the valve block 12B. Inside the valve block 12B, similar to the above-described case, various passages are formed in a manner to connect the ports 12a to 12e and the insertion openings 12h to 12k. By adopting this configuration, the cushion valve device 11B roughly in the shape of a cube can be manufactured.

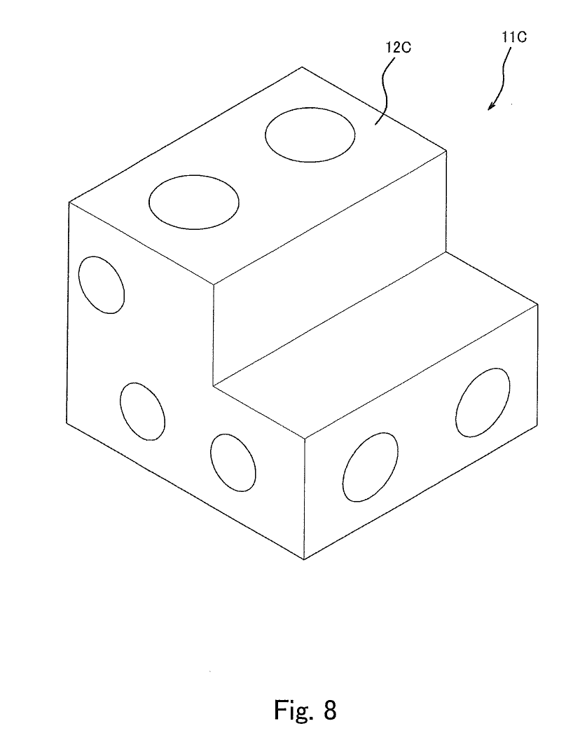

Further, as shown in FIG. 8, the cushion valve device 11C roughly L-shaped in side view, which includes a valve block 12C roughly L-shaped in side view, can be manufactured.

### Yet Another Embodiment

The above embodiments describe a case where the cushion valve unit 1 is applied to construction machines. However, the cushion valve unit 1 may be applied not only to construction machines but also to shipbuilding facilities, plant facilities, vehicles, etc. In the embodiments, it is not essential for the non-return valves 15 and 16 and the check valves 33 and 34 to be configured in the above-described manner, so long as the non-return valves 15 and 16 and the check valves 33 and 34 include the same mechanisms as those described above. For example, in the above-described embodiments, the non-return valves 15 and 16 and the check valves 33 and 34 are configured as cartridge-type check valves. However, as an alternative, the non-return valves 15 and 16 and the check valves 33 and 34 may be integrally formed in the valve block 12. Also, the arrangement and shapes of the ports 12a to 12e, the insertion openings 12h to 12k, and the passages 13, 14, 31, 32, and 45 are not limited to the above-described arrangement and shapes, but may be changed in accordance with, for example, designing and the shape of the valve block.

In the above-described embodiments, the first passage 13 and the second passage 14 are provided with the non-return valves 15 and 16, respectively, and are connected to the first discharge passage 31 and the second discharge passage 33, respectively. However, the configuration is not thus limited. That is, for example, the configuration may be such that only the second passage 14 is provided with the non-return valve 16, and the second discharge passage 33 is not formed in the valve block 12. With this configuration, when the operating tool 8a is operated in the one predetermined direction, reduction of an impact shock in the actuator and improvement in the responsiveness of the actuator can be achieved in accordance with the operating amount of the operating tool 8a as described above. When the operating tool 8a is operated in the other predetermined direction, the responsiveness of the actuator in accordance with the operating amount of the operating tool 8a can be obtained whatever the operating amount is.

Although in the above-described embodiments the operating tool 8a is an operating lever, the operating tool 8a may be a switch, dial, or the like. Although in the above-described embodiments the bypass passage 27 is formed in each of the non-return valves 15 and 16, the bypass passage 27 may be directly formed in the valve block 12.

From the foregoing description, numerous modifications and other embodiments of the present invention are obvious to one skilled in the art. Therefore, the foregoing description should be interpreted only as an example and is provided for the purpose of teaching the best mode for carrying out the present invention to one skilled in the art. The structural and/or functional details may be substantially altered without departing from the spirit of the present invention.

### REFERENCE SIGNS LIST

1, 1A cushion valve unit
4L, 4R switching valve
5L, 5R hydraulic cylinder
7a first pilot passage
7b second pilot passage
8L, 8R operating valve
8a operating tool
9a first supply/discharge passage
9b second supply/discharge passage
10 tank
11, 11B, 11C cushion valve device
12, 12B, 12C valve block
13, 13A first passage
14, 14A second passage
15 first non-return valve
16 second non-return valve
24a first throttle
24b second throttle
26a first non-return valve portion
26b second non-return valve portion
31, 31A first discharge passage
32, 32A second discharge passage
33 first pilot-to-open check valve (first check valve)
34 second pilot-to-open check valve (second check valve)
36 poppet valve element
38 piston
39 spring bearing member

1. A cushion valve device disposed between an operating valve and a switching valve, the operating valve being configured to supply pilot oil with a pressure corresponding to an operating amount of an operating tool to one of a first supply/discharge passage and a second supply/discharge passage in accordance with an operating direction of the operating tool, and connect another one of the first supply/discharge passage and the second supply/discharge passage to a tank, the switching valve being configured to switch a direction of hydraulic oil flowing to an actuator in accordance with a pressure difference between a first pilot passage connected to the first supply/discharge passage and a second pilot passage connected to the second supply/discharge passage,
the cushion valve device comprising:
a valve block including a first passage, a second passage, and a first discharge passage, the first passage including a first throttle and being disposed between the first supply/discharge passage and the first pilot passage, the second passage being disposed between the second supply/discharge passage and the second pilot passage, the first discharge passage branching off from the first passage between the first throttle and the first pilot passage and connecting the first passage and the tank; and
a first pilot-to-open check valve configured to open the first discharge passage when the pressure of the pilot oil that flows through the second supply/discharge passage has become higher than or equal to a predetermined pressure, and close the first discharge passage when the pressure of the pilot oil that flows through the second supply/discharge passage has become lower than the predetermined pressure, wherein
when the pressure of the pilot oil that flows through the second supply/discharge passage is lower than the predetermined pressure, the first pilot passage is connected to the tank via the first passage and the first supply/discharge passage.

2. The cushion valve device according to claim 1, wherein
the second passage includes a second throttle,
the valve block includes a second discharge passage, the second discharge passage branching off from the second passage between the second throttle and the second pilot passage and connecting the second passage and the tank,
a first non-return valve portion is provided on a first parallel passage of the first passage, the first parallel passage connecting a portion preceding the first throttle and a portion subsequent to the first throttle,
a second non-return valve portion is provided on a second parallel passage of the second passage, the second parallel passage connecting a portion preceding the second throttle and a portion subsequent to the second throttle,
the first non-return valve portion allows the pilot oil to flow from the first supply/discharge passage to the first pilot passage, and blocks a flow of the pilot oil in an opposite direction, and
the second non-return valve portion allows the pilot oil to flow from the second supply/discharge passage to the second pilot passage, and blocks a flow of the pilot oil in an opposite direction,
the cushion valve device comprising a second pilot-to-open check valve configured to open the second discharge passage when the pressure of the pilot oil that flows through the first supply/discharge passage has become higher than or equal to a predetermined pressure, and close the second discharge passage when the pressure of the pilot oil that flows through the first supply/discharge passage has become lower than the predetermined pressure, wherein
when the pressure of the pilot oil that flows through the first supply/discharge passage is lower than the predetermined pressure, the second pilot passage is connected to the tank via the second passage and the second supply/discharge passage.

3. The cushion valve device according to claim 2, wherein
the first pilot-to-open check valve is a cartridge-type valve, and is configured to be detachably inserted in the first discharge passage, and
the second pilot-to-open check valve is a cartridge-type valve, and is configured to be detachably inserted in the second discharge passage.

4. The cushion valve device according to claim 3, wherein
the first non-return valve portion and the first throttle are integrally formed as a cartridge-type valve and configured to be detachably inserted in the first passage, and
the second non-return valve portion and the second throttle are integrally formed as a cartridge-type valve and configured to be detachably inserted in the second passage.

5. A multi-cushion valve unit comprising a plurality of the cushion valve devices according to claim 1, wherein
the valve blocks of the plurality of the respective cushion valve devices are integrated together.

6. A multi-cushion valve unit comprising a plurality of the cushion valve devices according to claim 2, wherein
the valve blocks of the plurality of the respective cushion valve devices are integrated together.

7. A multi-cushion valve unit comprising a plurality of the cushion valve devices according to claim 3, wherein
the valve blocks of the plurality of the respective cushion valve devices are integrated together.

8. A multi-cushion valve unit comprising a plurality of the cushion valve devices according to claim 4, wherein
the valve blocks of the plurality of the respective cushion valve devices are integrated together.
